(19) United States
(12) Patent Application Publication
(10) Pub. No.: US 2005/0072586 A1
(43) Pub. Date: Apr. 7, 2005

(54) Axial sleeve device for pneumatic tool axle

(76) Inventor: Sun Ching Chu, Lung-Jing Hsiang (TW)

Correspondence Address: CHARLES E. BAXLEY, ESQUIRE, Third Floor, 90 John Street, New York, NY, 10038, US

(21) Appl. No.: 10/680,058

(22) Filed: Oct. 6, 2003

(51) Int. Cl. B25D 9/00; B25D 11/00

(52) U.S. Cl. 173/104; 173/171

(57) ABSTRACT

The present invention of a axial sleeve for pneumatic tool axle is for reducing friction and abrasion between a tool axial sleeve and a tool axle, the axial sleeve mainly comprises an axial sleeve, a bushing ring and steel balls, which are disposed on an annular groove and are annularly arranged as well as in contact with each other, accordingly, the axial sleeve and the tool axle can last longer, transmission is more precise without vibration and high temperature, which can cause injury of hands.

### BACKGROUND OF THE INVENTION

Conventional axial sleeve for pneumatic tool axle uses metallurgical method or mechanical processing to produce a cylindrical axial sleeve with its bottom end extended as a hat flange. It is then disposed inside the tool axle. The drawback is users will easily burn themselves by the high temperature generated from rubbing the tool axle and the axial sleeve. Plastic cover is the placed on the axial sleeve to protect users from burns.

The rubbing motion will create metal chips and scratches, and these chips or and scratches will even create a higher resistance to generate higher temperature and causes wear. The wear will then lead to abrasion of the tool axle and enlargement of the axial sleeve diameter, this will form caps between the elements. Vibration will then causes transmission becomes not smooth.

Obviously, conventional axial sleeve causes abrasion, higher temperature, deformation of tool axle and axial sleeve, caps are created and lead to vibration.

Other more precise bearing type products are found in the market, but are relatively more expensive for users. The steel balls used in the precise bearing have to be processed and are limited inside their placements. The disadvantage is that the steel balls are not in contact with other and this makes turning motion as the transmission method of the steel balls, thus cannot withstand high pressure.

The present invention of an axial sleeve device for pneumatic tool axle is structured in a way that the steel balls are in contact with other to create rolling abrasion in order to reduce the friction coefficient without reducing the output efficiency.

### SUMMARY OF THE PRESENT INVENTION

The present invention of an axial sleeve device for pneumatic tool axle mainly comprises an axial sleeve, a bushing ring and a plurality of steel balls arranged annularly and are in contact with other. So that abrasion is reduced, lower temperature is generated, the tool axle will not change in shape or be worn-out, thus can prolong the durability of the tool axle and the axial sleeve. The steel balls are arranged annularly and are in contact with each other, this arrangement can stand higher pressure and can reduce wear by using rolling method for transmission.

The present invention will become more fully understood by reference to the following detailed description thereof when read in conjunction with the attached drawings

### BRIEF DESCRIPTION OF THE DRAWING

FIG. 1 is a perspective exploded view of the present invention of an axial sleeve device for pneumatic tool axle;

FIG. 2 is a sectional view of a preferred embodiment of the present invention of an axial sleeve device for pneumatic tool axle;

FIG. 3 a sectional view of FIG. 2 on line A-A;

FIG. 4 is a sectional view of another preferred embodiment of the present invention of an axial sleeve device for pneumatic tool axle;

FIG. 5 a sectional view of the present invention of an axial sleeve device for pneumatic tool axle in operation.

### DETAILED DESCRIPTION OF THE PREFERRED EMBODIMENT

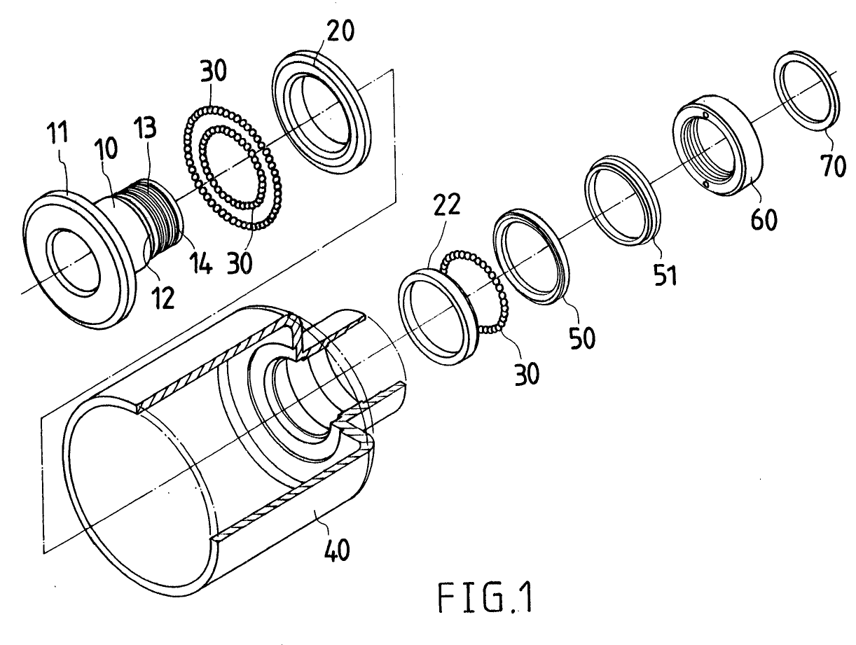

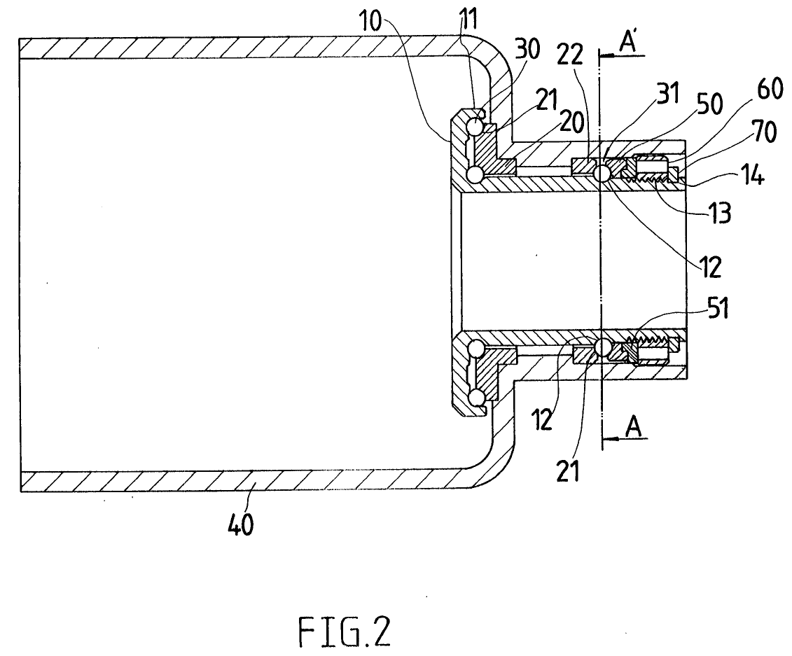

Referring to FIGS. 1 and 2, the present invention of an axial sleeve device for pneumatic tool axle mainly comprises a locking element, which is an axial sleeve (10); a middle element, which is a plurality of steel balls (30) arranged annularly and are in contact with each other; a front locking part, which is a combination of bushing rings (20) and (22), a pad ring (51), a rubber ring (50), a screw nut (60) and a spring pad (70).

The axial sleeve (10), which is in cylindrical shape with a L-shape identical sectional surface, having a protruded flange (11) at its end. The pair of bushing rings (20) and (22) is disposed on the axial sleeve (10).

The steel balls (30) are arranged annularly and having grooves (12) and (21) in corresponding to the axial sleeve (10) and the pair of bushing rings (20) and (22) respectively. Please refer to FIG. 2, steel balls ring (31) is formed as the steel balls (30) are arranged annularly and are in contact with each other.

An outer shell (40) is used to hole all the elements inside, the axial sleeve (10) and the screw nut (60) are positioned inside the outer shell (40).

A threading (13) is disposed on one end of the axial sleeve (10). After the bushing ring (20), the steel balls (30), the pad ring (51) and the rubber ring (50) act as buffer elements are assembled in order, screw and lock the screw nut (60) on the threading (13) of the axial sleeve (10).

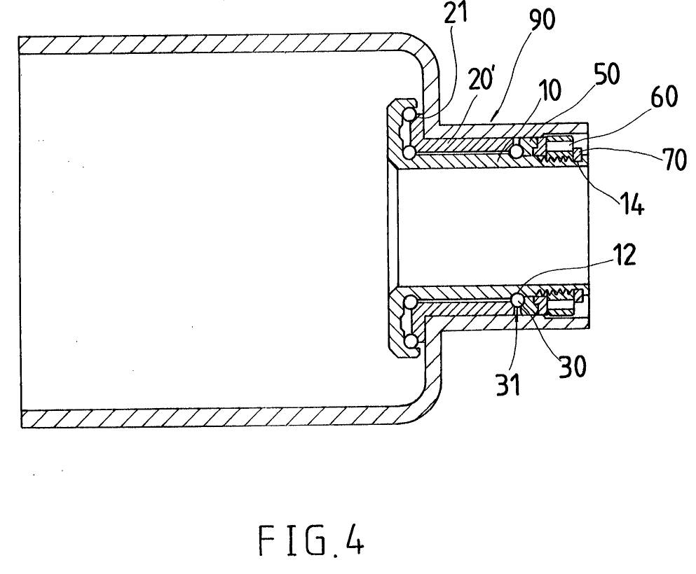

Referring to FIG. 4, which is another preferred embodiment of the present invention of an axial sleeve device for pneumatic tool axle. The bushing ring (20) of a tool axial sleeve (90) is made as the bushing rings (20) and (22) as shown in FIG. 1, or made as a one-piece bushing ring (20′), as shown in FIG. 4. This depends on how the thickness of the outer shell (40), the way which is processed during manufacturing. If the outer shell (40) is thicker after being processed, a combination of bushing rings (20) and (22) can be applied. On the contrary, if the outer shell (40) is less thick after being processed, the one-piece bushing ring (20′) will be more suitable.

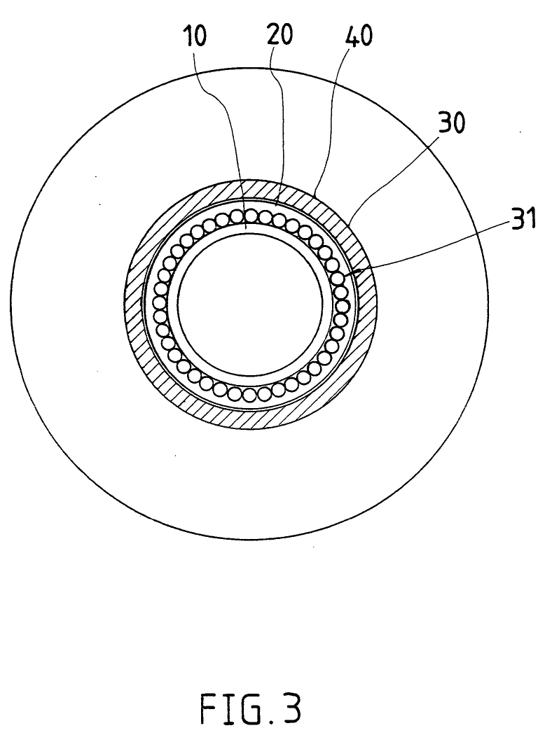

Accordingly, place the steels balls (30) on the axial sleeve (10), the groove (12) and the annularly arranged steel balls (30) which are in contact with each other, form the steel balls ring (31) as shown in FIG. 3. Then sleeve the bushing ring (20′) with the groove (21) in corresponding with the steel balls ring (31), then place the rubber ring (50) and screw the screw nut (60) on the threading (13) of the axial sleeve (10). Annular groove (14) is disposed on the axial sleeve (10) for placing the spring pad (70), so as to prevent the screw nut (60) from loosing.

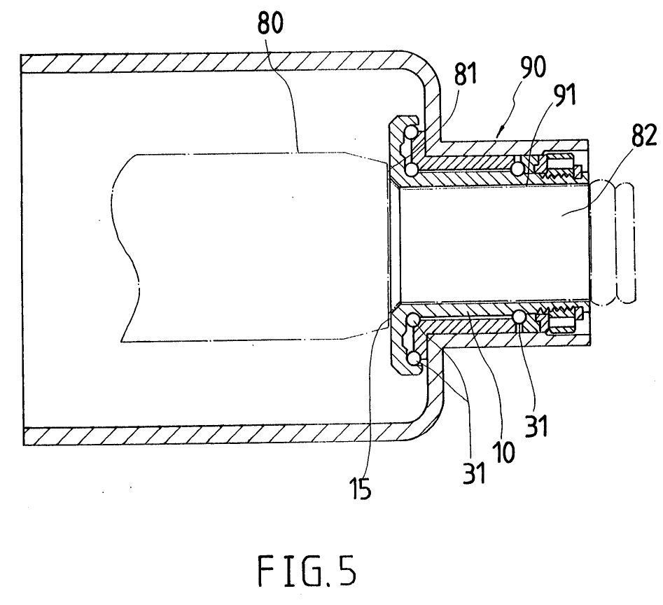

Referring to FIG. 5, which shows the present invention in operation. When a pneumatic tool (80) and the tool axial sleeve (90) are sleeved together for operation, a pressure surface (81) is pressed against a vertical surface (15) of the axial sleeve (10) of the tool axial sleeve (90), the pressure is distributed evenly on the steel balls ring (31), which is disposed on the two sides of the vertical surface (15). Thus friction coefficient can be reduced and the steel balls ring (31) can stand high pressure. A tool axle (82) is disposed through a center hole (91) of the tool axial sleeve (90). So that when the tool axle (82) turns at a high speed, the axial sleeve (10) also turns together with the tool axle (82). While the steel balls ring (31) acts as a middle element to reduce friction surface and will not generate high temperature.

Without having to increase production cost, the present invention of an axial sleeve device for pneumatic tool axle can stand high pressure, as well as reduce friction and temperature. The tool axle can last longer with more precise transmission, and without the vibration problem caused by caps created by abrasion.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. An axial sleeve device for pneumatic tool axle mainly comprises
an axial sleeve, which is in cylindrical shape with a L-shape identically sectional surface, having one end as a protruded flange;
a bushing ring (20) for sleeving on said axial sleeve;
an annular steel balls, which are in contact with other and are arranged as a steel balls ring in corresponding to an annular groove disposed on said axial sleeve and said bushing ring respectively, accordingly, without increasing production cost, said steel balls ring can stand high pressure and can reduce friction and abrasion for prolonged durability of a tool axle.

2. An axial sleeve device for pneumatic tool axle as claimed in claim 1, an outer shell is used to cover said axial sleeve and to position said axial sleeve and a screw nut.

3. An axial sleeve device for pneumatic tool axle as claimed in claim 1, said axial sleeve having a threading and said annular groove.

4. An axial sleeve device for pneumatic tool axle as claimed in claim 1, said axial sleeve having buffer elements and positioning elements.

5. An axial sleeve device for pneumatic tool axle as claimed in claim 4, said buffer elements could be a pad ring and/or a rubber ring.

6. An axial sleeve device for pneumatic tool axle as claimed in claim 4, said positioning elements could be said screw nut and/or a spring pad.

7. An axial sleeve device for pneumatic tool axle as claimed in claim 1, said bushing ring could be a combination of two or more pieces or in one-piece according to the thickness of said outer shell after different processing methods.

8. An axial sleeve device for pneumatic tool axle, comprises
a locking element for pressing against the surface of said tool axle and said tool axial sleeve;
a middle element is formed by said steel balls annularly and are in contact with each other;
a front locking element for preventing said middle element from loosing,
accordingly, friction coefficient could be reduced but without reduction in output efficiency.

9. An axial sleeve device for pneumatic tool axle, said steel balls ring is disposed on said annular groove and is formed by said steel balls, which are annularly arranged and are in contact with each other.
